(19) United States
(12) Patent Application Publication
(10) Pub. No.: US 2015/0363739 A1
(43) Pub. Date: Dec. 17, 2015

(54) PROJECT RESOURCE SELECTION BASED ON COMPATIBILITY

(71) Applicant: Oracle International Corporation, Redwood Shores, CA (US)

(72) Inventors: Vaibhav APARIMIT, Bangalore (IN); Manish KUMAR, Bangalore (IN); Raghavan SRINIVASAN, Bangalore (IN)

(21) Appl. No.: 14/302,483

(22) Filed: Jun. 12, 2014

(51) Int. Cl. G06Q 10/06

(52) U.S. Cl. CPC G06Q 10/063118

(57) ABSTRACT

A project team creator is provided that recommends project teams. The project team creator provides a project demand profile and generates a plurality of suggested project teams, the generating including building a graph of each of the plurality of suggested project teams. The project team creator determines a compatibility metric for each of the plurality of suggested project teams and determines a ranking of each of the plurality of suggested project teams based on the corresponding compatibility metric. The project team creator then outputs the ranking of each of the plurality of suggested project teams and the graph of each of the plurality of suggested project teams.

### FIELD

One embodiment is directed generally to a computer system, and in particular to a computer system that generates and ranks combinations of resources to staff a project team based on a compatibility metric.

### BACKGROUND INFORMATION

Project management is the process and activity of planning, organizing, motivating, and controlling resources, procedures and protocols to achieve specific goals in scientific or daily problems. A project is a temporary endeavor designed to produce a unique product, service or result with a defined beginning and end (usually time-constrained, and often constrained by funding or deliverables), undertaken to meet unique goals and objectives, typically to bring about beneficial change or added value. The temporary nature of projects stands in contrast with business as usual (or operations), which are repetitive, permanent, or semi-permanent functional activities to produce products or services.

Resource management is the efficient and effective deployment of an organization's resources when they are needed. Such resources may include financial resources, inventory, human skills, production resources, or information technology (“IT”).

In the realm of project management, processes, techniques and philosophies as to the best approach for allocating resources have been developed. These include discussions on functional vs. cross-functional resource allocation as well as processes espoused by organizations like the Project Management Institute (“PMI”) through their Project Management Body of Knowledge (“PMBOK”) methodology of project management. Resource management is a key element to activity resource estimating and project human resource management. Both are essential components of a comprehensive project management plan to execute and monitor a project successfully.

However, project and resource management across industry verticals may not take into account the effect of the nature of alliances, rapport, and association between any two project team members before forming a project team. The positive and/or negative collaborative force between team members may impact project deliverables.

### SUMMARY

One embodiment is a system that recommends project teams. The system provides a project demand profile and generates a plurality of suggested project teams, the generating including building a graph of each of the suggested project teams. The system determines a compatibility metric for each of the suggested project teams and determines a ranking of each of the suggested project teams based on the corresponding compatibility metric. The system then outputs the ranking of each of the suggested project teams and the graph of each of the suggested project teams.

### BRIEF DESCRIPTION OF THE DRAWINGS

FIG. 1 is a block diagram of a computer system that can implement an embodiment of the present invention.

FIG. 2 illustrates an enterprise resource pool represented as a graph and a corresponding matrix in accordance with one embodiment.

FIG. 3A is a flow diagram showing the functionality for determining team compatibility scores in accordance with one embodiment.

FIG. 3B is a flow diagram showing the functionality for generating suggested project teams and ranking the suggested project teams based on a determined metric in accordance with one embodiment.

FIG. 4 illustrates a graph of an enterprise resource pool in accordance with one embodiment.

FIG. 5 illustrates a graph of a first suggested project team in accordance with one embodiment.

FIG. 6 illustrates a graph of a second suggested project team in accordance with one embodiment.

FIG. 7 illustrates a graph of a third suggested project team in accordance with one embodiment.

### DETAILED DESCRIPTION

One embodiment is a system that utilizes compatibility scores of team members to recommend project teams. The system can generate and rank suggested project teams based on compatibility scores that take into account prior professional associations amongst the team members. The system can provide the suggested project teams and their determined rankings to a project manager and/or resource manager to aid in the project staffing decision making process. In some embodiments, the system displays a graph visualization of the suggested project teams to further aid the decision making process.

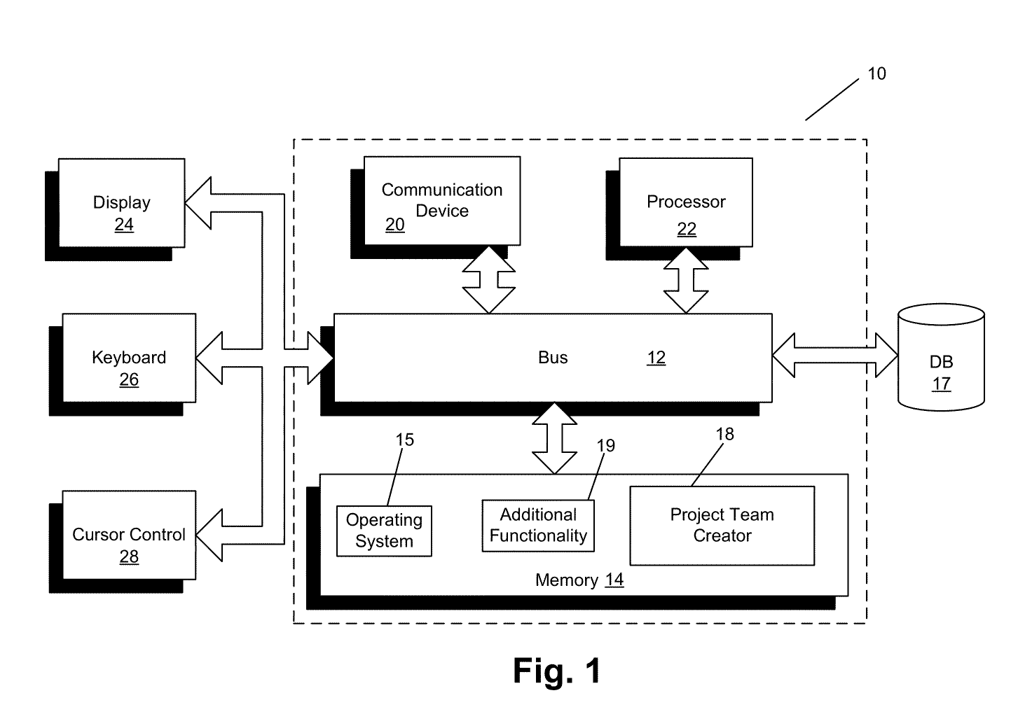

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a project team creator (or “project creator”) 18 that generates suggested project teams, as disclosed in more detail below. System 10 can be part of a larger system, such as an enterprise resource planning (“ERP”) system. Therefore, system 10 will typically include one or more additional functional modules 19 to include the additional functionality. A database 17 is coupled to bus 12 to provide centralized storage for modules 18 and 19 and store project management information, resource information, etc.

In one embodiment, system 10 suggests one or more project teams based on a project demand profile and an enterprise resource pool. In some embodiments, system 10 quantifies compatibility and prior professional associations amongst individuals available in the enterprise resource pool to form project teams by determining one or more types of compatibility metrics for each suggested project team. The compatibility metrics can factor in “human-relationship” elements between individuals before forming a project team. In some embodiments, system 10 utilizes one or more of the three approaches to determining compatibility metrics described below (“Simple Density Metric,” “Reciprocal Density Metric,” and “Triangular Density Metric”) and can display (e.g., via display 24) graphical representations of suggested project teams, which can be used by both project managers and resource managers to staff individuals in a project team and thereby create the most optimal project team aligned with the goals of a project or resource manager.

A “project team” can include a collection of individuals in an organization who work interdependently towards achieving common and shared goals of a project. Project teams can be divided into sub teams and are typically used during a definite period of time. They are disbanded after the project goals are achieved. A high performing project team desires strong collaborative attitude to succeed.

A “project demand profile” is a list of roles, skills, proficiency, ability, duration of engagement etc. of resources required to achieve project deliverables. It can be prepared by a project manager and can be fulfilled by a resource manager. Creation and fulfilment of the project demand profile is agnostic to the data around working relationship and “collaborative-tension” between individuals working together. The project demand profile can be any data that describes the roles to be filled for a particular project.

A “project manager” can be responsible for articulating clear and attainable project objectives, building the project requirements, and managing the constraints of the project management triangle, which are cost, time, scope, and quality. A project manager can also responsible for building the project team, by specifying in a project demand profile the roles, skills, proficiency, abilities etc of resources needed in a project team. The project demand profile can then sent to a resource manager to staff resources based on the project demand profile.

A “resource manager” can be the person in charge of making effective and efficient deployment of resources towards a project. A resource manager may receive multiple project demand profile fulfilment requests for staffing project teams from project managers in an organization.

According to Tuckman's group development model, in the first stage of team building, the forming of the team takes place. The individual's behavior may be driven by a desire to be accepted by the others, and/or avoid controversy/conflict. Serious issues and feelings may be avoided, and people may focus on being busy with routines (e.g., team organization, who does what, when to meet each other, etc.). Individuals may also be gathering information and impressions—about each other, and about the scope of the task and how to approach it. The forming stage is a comfortable stage to be in, but the avoidance of conflict and/or threat may lead to not much actually getting done. The team may meet and learn about the opportunities and challenges, and then agree on goals and begin to tackle the tasks. Team members may tend to behave quite independently. They may be motivated but are usually relatively uninformed of the issues and objectives of the team. Team members may be on their best behavior but focused on themselves. Mature team members may begin to model appropriate behavior even at this early phase.

The forming stage of any team is important because, for example, in this stage, the members of the team get to know one another, exchange some personal information, and make new friends. This stage is also a good opportunity to see how each member of the team works as an individual and how they respond to pressure.

Teams will next enter the storming stage in which different ideas may compete for consideration. The team may addresses issues (e.g., what problems they are really supposed to solve, how they will function independently and together, and what leadership model they will accept). Team members may open up to each other and/or confront each other's ideas and perspectives. In some cases storming can be resolved quickly. In some other cases, the team never leaves this stage. The maturity of some team members usually determines whether the team will ever move out of this stage. Some team members may focus on minutiae to evade real issues.

The storming stage contributes to the growth of the team. It can be contentious, unpleasant and/or even painful to members of the team who are averse to conflict. Tolerance of each team member and their differences should be emphasized. Without tolerance and/or patience the team may fail. This phase can become destructive to the team and may lower motivation if allowed to get out of control. Some teams will never develop past this stage.

Supervisors of the team during the storming stage may be more accessible, but may tend to remain directive in their guidance of decision-making and professional behavior. The team members may resolve their differences and members may be able to participate with one another more comfortably. The ideal is that they will not feel that they are being judged, and will therefore share their opinions and views. Normally tension, struggle and sometimes arguments occur. This stage can also be upsetting.

During the storming stage, the team manages to have one goal and come to a mutual plan for the team at this stage. Some may have to give up their own ideas and agree with others to make the team function. In this stage, all team members may take the responsibility and have the ambition to work for the success of the team's goals. A danger here is that some members may be so focused on preventing conflict that they are reluctant to share controversial ideas.

It is possible for some teams to reach the next stage, the performing stage. These high-performing teams can function as a unit as they find ways to get the job done smoothly and effectively without, for example, inappropriate conflict and/or the need for external supervision. By this time, they may be motivated and may be knowledgeable. The team members may now be competent, may be autonomous and may be able to handle the decision-making process without supervision. Dissent may be expected and may be allowed as long as it is channeled through means acceptable to the team.

Supervisors of the team during this phase may be participative. The team may make most of the necessary decisions. Even the most high-performing teams can revert to earlier stages in certain circumstances. Many long-standing teams go through these cycles many times as they react to changing circumstances. For example, a change in leadership may cause the team to revert to storming as the new people challenge the existing norms and dynamics of the team.

Embodiments take into account the nature of alliances and associations between team members such as prior professional associations by running an analysis on historical data such as, for example, data pertaining to prior project membership. When two people have worked together in previous projects they generally have an idea on each other's work styles (e.g., knowing each other's strengths, weaknesses, and pain points) which may make it easy to reduce the number of conflicts in the storming stage and may enable the team to jump to the norming and/or performing stages.

For example, if a first team member likes to go to church on Sundays and a second team member likes to party on Friday, then if they have worked together in the past the second team member may already know to avoid giving the first team member tasks to complete on Sunday and the first team member may already know to avoid assigning tasks to be completed on Friday for the second team member.

In order to create a project team, project createor 18 can utilize the compatibility scores, discussed below, to select and/or rank project teams from the set of recommended/suggested project teams. In some embodiments, a graph visualization of recommended project teams can be displayed (e.g., on display 24) to a user (e.g. a project or resource manager) to further aid the decision making process.

A project team can be formed by a project manager or by a resource manager. Both these managers will be recommended project teams based on attributes such as, for example, skills, proficiency, cost etc. of the team members. These attributes, along with the number of team members, can be included in a project demand profile that is used by system 10 to generate suggested project teams.

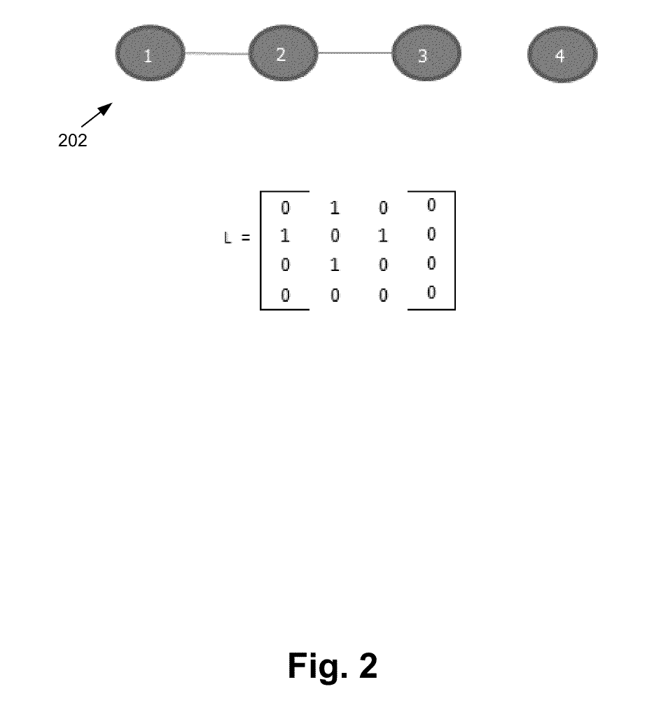

FIG. 2 illustrates an enterprise resource pool represented as a graph 202 and a corresponding matrix L in accordance with one embodiment. An organization's resource pool (or enterprise resource pool) from which resources may be selected to generate the suggested project teams can be represented as graph 202 and the corresponding matrix L. Graph 202 can include nodes 1-4 representing the four employees in the enterprise resource pool represented by graph 202.

For FIGS. 2 and 4-7, all individuals who are part of an organization's resource pool (or enterprise resource pool) will be referred to as nodes, and the set of nodes N={1,2,3,4, . . . , n} represents all employees 1,2,3,4, . . . n in the organization. The relationship between two individuals is represented by a link between their corresponding nodes. In the case where two individuals have previously worked together, there will be a link connecting their corresponding nodes. In case two individuals haven't worked together, there will be no link connecting their respective nodes. A link connecting nodes i, j will be represented as Iᵢⱼ.

In some embodiments, the representation of employees and their connections takes the form of a canonical undirected graph in which two nodes are either connected or they are not connected. The entire enterprise resource pool can be represented as a graph (N,L) consisting of nodes N={1,2,3,4, . . . , n} and real valued matrix n×n matrix L, where Iᵢⱼ represents the link between nodes i and j.

The shortest path between nodes i and j is defined by the minimum total number of sequence of links encountered while traversing the graph from node i to node j. The shortest path between node i and j will be denoted by Sᵢⱼ. Theoretically, for two unconnected nodes i and j, Sᵢⱼ will be infinity. A sub-graph(K,L′) of graph(N,L) is a non-empty graph such that K⊂N, L′⊂L.

Returning to FIG. 2, node 1 is linked/connected to node 2 representing that the respective employees have worked together in the past, and node 2 is linked/connected to node 3 representing that the respective employees have worked together in the past. Node 1 and node 3 are not directly linked/connected, which represents that employee 1 has not worked with employee 3. Node 4 is not linked/connected to any other node, which represents that none of employees 1-3 have worked with employee 4.

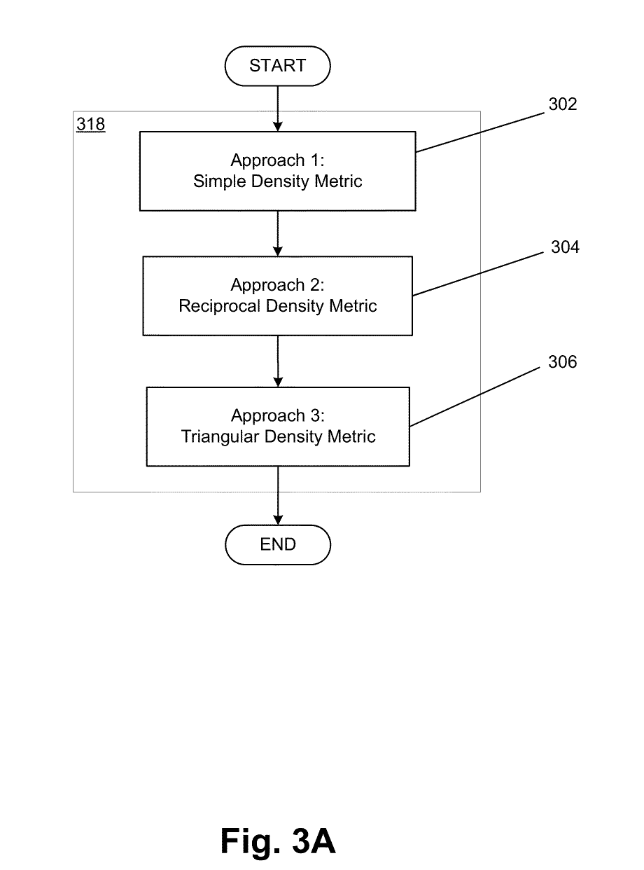

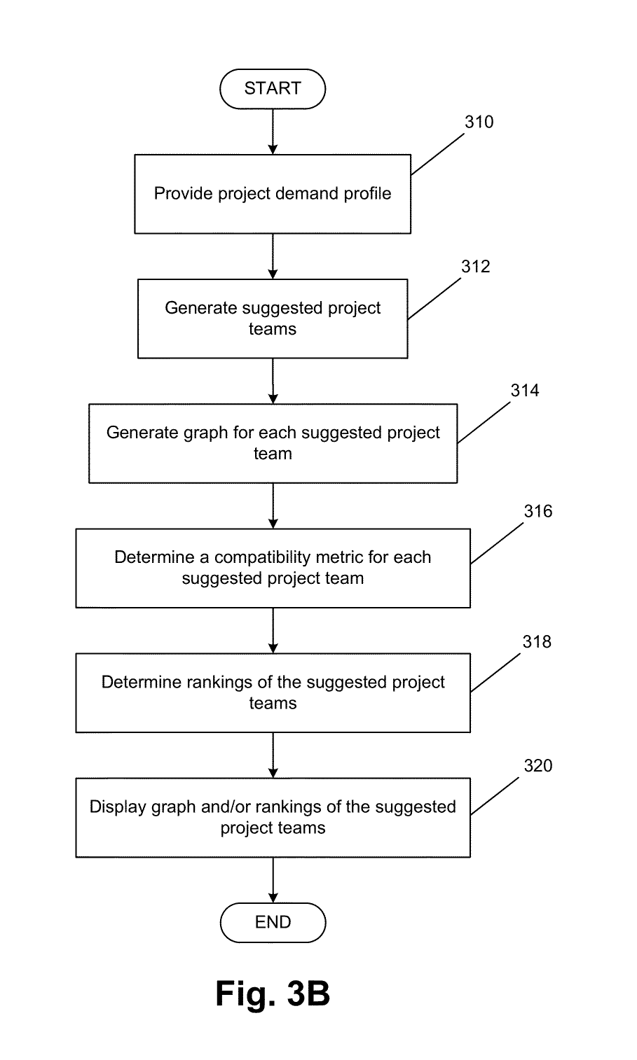

In graph 202, the shortest distance between nodes 1 and 2, S₁₂, is 1 and the shortest distance between nodes 2 and 3, S₂₃, is also 1. The shortest distance between nodes 1 and 3, S₁₃, is 2. The shortest distance between node 4 and any other node is infinity. This tractable representation of the entire resource pool in a graph form as discussed above enables determining team compatibility scores as described in FIGS. 3A and 3B below.

FIG. 3A is a flow diagram showing the functionality for determining team compatibility scores in accordance with one embodiment. In one embodiment, the functionality of the flow diagram of FIG. 3A, and FIG. 3B, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

For each the approaches discussed below (302, 304, and 306), assume a graph(N,L) which represents the entire organizational resource pool, where N is the set of nodes, N={1,2,3, . . . , n} and L is a n×n matrix such that (i,j)^{th} element, Iᵢⱼ represents the link between nodes i and j. Sᵢⱼ represents the shortest path between nodes i and j.

In some embodiments, when, based on the demand profile, multiple teams of k members have been suggested by the system where k<n, the objective is to choose the most compatible team represented by sub-graph(K,L′) containing k nodes, from the set of all suggested sub-graphs with k nodes.

At 302, module 18 determines a compatibility score of a project team according to approach 1 (Simple Density Metric). Under approach 1 (Simple Density Metric), individuals who have worked together previously will find it easier to overcome the forming/storming stage and reach the norming stage as per Tuckman's group development model. Compatibility metrics calculated using this approach capture the extent of prior professional associations within the project team.

To determine the Simple Density Metric compatibility score, module 18 can perform the following:
Choose any sub-graph(K,L′) from the set of all suggested sub-graphs with k nodes.
For each node in the sub-graph(K,L′), calculate the sum of shortest distances to all the other nodes of the same sub-graph. Hence, for iεK, calculate Sᵢ=ΣSᵢⱼ, where i≠j, ∀jεK. In case there is no direct or indirect link between two nodes, the shortest distance can be assumed to be a very large natural number, such as, for example, two times the total number of resources in the organizational resource pool.
Add the values calculated for each node in sub-graph(K,L′), to arrive at the value of compatibility score. Hence, a score=ΣSᵢ, ∀iεK.

The Simple Density Metric compatibility score of a sub-graph, calculated as described above, can represent how dense the interconnections between individuals in a project team are. The lower the value of the compatibility score, the more gelled the project team will be and vice-versa.

At 304, module 18 determines a compatibility score of a project team according to approach 2 (Reciprocal Density Metric). Similar to the Simple Density Metric, compatibility metrics calculated using the Reciprocal Density Metric approach also captures the extent of prior professional associations within a project team.

To determine the Reciprocal Density Metric compatibility score, module 18 can perform the following:
Choose any sub-graph(K,L′) from the set of all suggested sub-graphs with k nodes.
For each node in the sub-graph(K,L′), calculate the sum of the inverse of the shortest distances to all the other nodes of the same sub-graph. Hence, for iεK, calculate Sᵢ=Σ(1/Sᵢⱼ), where i≠j, ∀jεK. In case there is no direct or indirect link between two nodes, the shortest distance can be set to be infinity.
Add the values calculated for each node in sub-graph(K,L′), to arrive at the value of compatibility score. Hence, a score=ΣSᵢ, ∀iεK.

The Reciprocal Density Metric compatibility score for a sub-graph, calculated as shown above, can represent how dense the interconnections between individuals in a project team are. The higher the value of the compatibility score, the more gelled the project team will be and vice-versa.

In some embodiments, because unconnected nodes are assigned a shortest distance of infinity, the Reciprocal Density Metric compatibility score may handle unconnected nodes more accurately than the Simple Density Metric compatibility score discussed above.

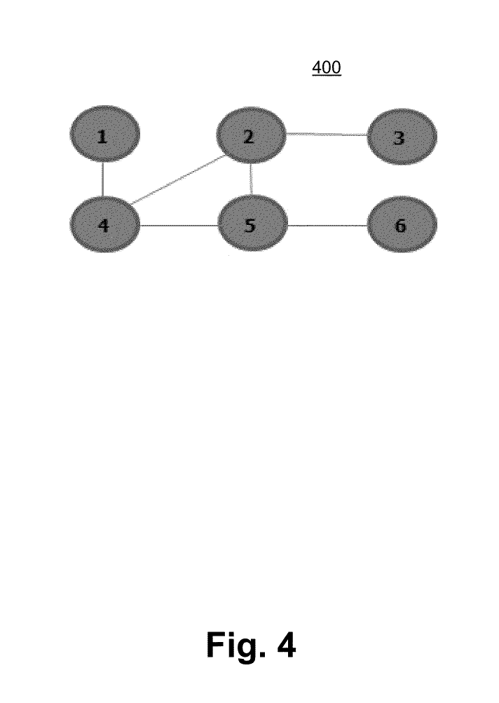

At 306, module 18 determines a compatibility score of a project team according to approach 3 (Triangular Density Metric). Compatibility metrics calculated using the Triangular Density Metric approach measure the clustering or “clique”-ness inside a project team. Under this approach, the metric measures the extent to which, for members with two or more connections, the two or more connections are themselves connected to each other. For example, node 4 of FIG. 4 described below is connected to nodes 2 and 5, and nodes 2 and 5 are themselves connected to each other. Thus, nodes 2, 4, and 5 form a cluster, or clique.

To determine the Triangular Density Metric compatibility score, module 18 can perform the following:
Choose any sub-graph(K,L′) of the graph(N,L)
For each node in the sub-graph(K,L′), look at cases where two links emanate from the same node. So say ij and ik emanate from node i and find out whether jk belongs to same sub-graph. Hence, the score=(ΣI′ᵢⱼI′ᵢₖI′ₖⱼ)/(ΣI′ᵢⱼI′ᵢₖ) where i, j, kεK, i≠j, i≠k, k≠j

The Triangular Density Metric compatibility score for a sub-graph, calculated as described above, represents how clustered the interconnections between individuals in a project team are. The higher the value of the Triangular Density Metric compatibility score, the more connected and gelled the project team will be and vice-versa.

In embodiments, module 18 can determine one or more of the metrics described above (e.g., module 18 can perform one or more of 302, 304, and 306).

FIG. 3B is a flow diagram showing the functionality for generating suggested project teams and ranking the suggested project teams based on a determined metric in accordance with one embodiment.

At 310, a project demand profile is provided. The project demand profile can define the roles needed to be filled to for a new team.

At 312, module 18 generates suggested project teams based on the project demand profile and a resource pool of available resources, such as an enterprise resource pool. The suggested project teams can be generated as described above with respect to FIGS. 1, 2, and 3A and as described below with respect to FIGS. 4-7. In some embodiments, the project demand profile and enterprise resource pool can be stored in one or more databases, such as database 17 of FIG. 1.

At 314, module 18 generates a graph for each suggested project team. As described above, the graph can be a canonical undirected graph with nodes that represent the resources of the enterprise resource pool and connections between two nodes of the graph can represent a prior professional association between the two resources (or employees) corresponding to the two nodes.

At 316, module 18 determines a compatibility metric for each suggested project team. The compatibility metric can be determined as discussed above with respect to FIG. 3A.

At 318, module 18 determines rankings for the suggested project teams. The rankings can be determined as discussed above with respect to FIG. 3A and as discussed below with respect to FIGS. 4-7.

At 320, module 18 outputs the graph and/or rankings of the suggested project teams. For example, module 16 can output the graphs and/or rankings on a display such as display 14 of FIG. 1. Alternatively or additionally, module 16 can output the graphs and rankings to email or other electronic messaging system to be emailed or electronically transmitted to a recipient and/or a printer to be printed.

Examples are provided below in FIGS. 4-7 to show the ranking determinations performed at 318 in some embodiments to rank suggested project teams selected from an enterprise resource pool based on a project demand profile.

FIG. 4 illustrates a graph 400 of an enterprise resource pool in accordance with one embodiment. Graph 400 represents an enterprise resource pool that comprises six members (or resources). Resources of the pool are represented by nodes 1-6 and prior professional associations are represented by links between nodes.

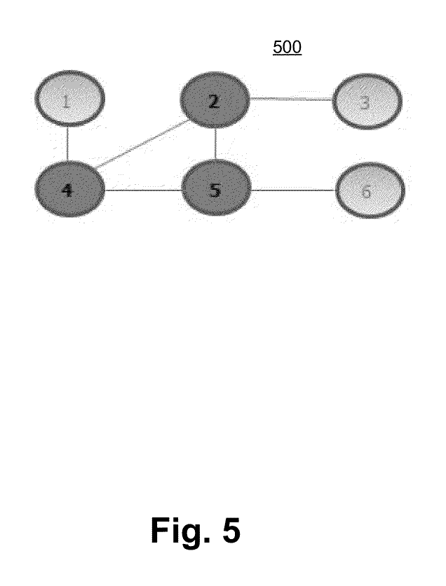

In some embodiments, when a project team of three members, each with certain attributes (like skill, role, proficiency etc.), is desired to be created from the enterprise resource pool represented by graph 400, project creator 18 can generate, based on skill, proficiency, cost and other attributes of the team members, the suggested project teams illustrated in FIGS. 5-7. For example, the number of team members desired, along with the desired attributes (like skill, role, proficiency etc.) for each member, can be included in a project demand profile that is provided and/or made available to project creator 18.

FIG. 5 illustrates a graph 500 of a first suggested project team in accordance with one embodiment. Graph 500 includes a first suggested team comprising nodes 2, 4 and 5 as members. Nodes 1, 3, and 6 representing the remaining resources from the enterprise resource pool are not part of the first suggested project team.

In some embodiments, graph 500 is a graphical visualization displayed to a user (e.g., via display 24) to provide a graphical visualization of the connections between the selected members. For example, a user can infer from the graphical visualization of the first suggested project team that this team has dense connections as the each team member is linked to (or knows) every other team member. Alternatively or additionally, project creator 18 can rank suggested project teams based on the compatibility metrics discussed above with regard to FIG. 2.

For example, project creator 18 can determine a compatibility metric for the first suggested project team using approach 1 (Simple Density Metrics) as shown below:

Node 2: S₂=S₂₄+S₂₅=1+1=2

Node 4: S₄=S₄₂+S₄₅=1+1=2

Node 5: S₅=S₅₂+S₅₄=1+1=2

Compatibility Score=S₂+S₄+S₅=2+2+2=6

Project creator 18 can also determine a compatibility metric for the first suggested project team using approach 2 (Reciprocal Density Metrics) as shown below:

Node 2: S₂=(1/S₂₄)+(1/S₂₅)=1+1=2

Node 4: S₄=(1/S₄₂)+(1/S₄₅)=1+1=2

Node 5: S₅=(1/S₅₂)+(1/S₅₄)=1+1=2

Compatibility Score=S₂+S₄+S₅=2+2+2=6

Project creator 18 can also determine a compatibility metric for the first suggested project team using approach 3 (Triangle Density Metrics) as shown below:

Overall Score=(I₂₄I₂₅I₄₅+I₄₅I₄₂I₂₅+I₅₄I₅₂I₄₂)/(I₂₄I₂₅+I₄₅I₄₂+I₅₄I₅₂)=(1+1+1)/(1+1+1)=1

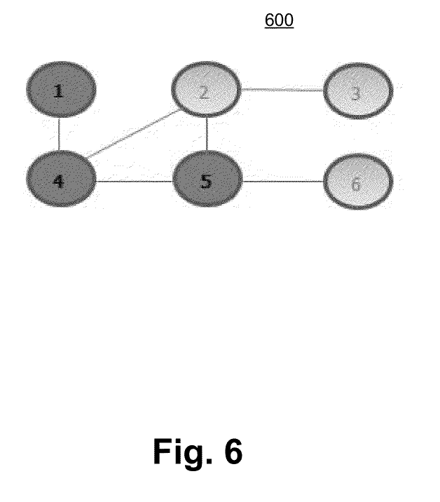

FIG. 6 illustrates a graph 600 of a second suggested project team in accordance with one embodiment. Graph 600 includes a second suggested project team comprising nodes 1, 4 and 5 as members. Nodes 2, 3, and 6 representing the remaining resources from the enterprise resource pool are not part of the second suggested project team.

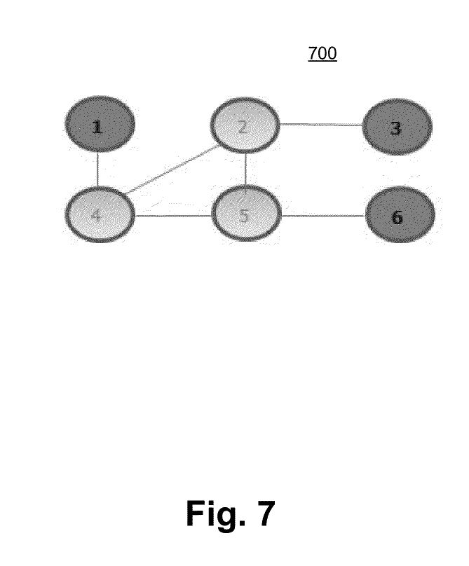

In some embodiments, graph 600 is a graphical visualization displayed to a user (e.g., via display 24) to provide a graphical visualization of the connections between the selected members. For example, a user can infer from the graphical visualization that the second suggested team has two links, so it less dense that the first suggested team but denser than the third suggested team shown in FIG. 7.

In some embodiments, project creator 18 ranks suggested project teams based on the compatibility metrics discussed above with regard to FIG. 2.

For example, project creator 18 can determine a compatibility metric for the second suggested project team using approach 1 (Simple Density Metrics) as shown below:

Node 1: S₁=S₁₄+S₁₅=1+2=3

Node 4: S₄=S₄₁+S₄₅=1+1=2

Node 5: S₅=S₅₁+S₅₄=2+1=3

Overall Score=S₁+S₄+S₅=3+2+3=8

Project creator 18 can also determine a compatibility metric for the second suggested project team using approach 2 (Reciprocal Density Metrics) as shown below:

Node 1: Sᵢ=(1/S₁₄)+(1/S₁₅)=1+½=3/2

Node 4: S₄=(1/S₄₁)+(1/S₄₅)=1+1=2

Node 5: S₅=(1/S₅₁)+(1/S₅₄)=½+1=3/2

Overall Score=S₁+S₄+S₅=3/2+2+3/2=5

Project creator 18 can also determine a compatibility metric for the second suggested project team using approach 3 (Triangle Density Metrics) as shown below:

Overall Score=(I₁₄I₁₅I₄₅+I₄₅I₄₁I₁₅+I₅₄I₅₁I₄₁)/(I₁₄I₁₅+I₄₅I₄₁+I₅₄I₅₁)=(0+0+0)/(1+1+1)=0

FIG. 7 illustrates a graph 700 of a third suggested project team in accordance with one embodiment. Graph 700 includes a third suggested project team comprising nodes 1, 3 and 6 as members. Nodes 2, 4, and 5 representing the remaining resources from the enterprise resource pool are not part of the third suggested project team.

In some embodiments, graph 700 is a graphical visualization displayed to a user (e.g., via display 24) to provide a graphical visualization of the connections between the selected members. For example, a user can infer from the graphical visualization that none of the team members (nodes) have direct links to each other, so this suggested project team has the least dense connections of the suggested project teams shown in FIGS. 5-7.

In some embodiments, project creator 18 ranks suggested project teams based on the compatibility metrics discussed above with regard to FIG. 2.

For example, project creator 18 can determine a compatibility metric for the third suggested project team using approach 1 (Simple Density Metrics) as shown below:

Node 1: S₁=S₁₃+S₁₆=3+3=6

Node 3: S₃=S₃₁+S₃₆=3+3=6

Node 6: S₆=S₆₁+S₆₃=3+3=6

Overall Score=S₁+S₃+S₆=6+6+6=18

Project creator 18 can also determine a compatibility metric for the second suggested project team using approach 2 (Reciprocal Density Metrics) as shown below:

Node 1: S₁=(1/S₁₃)+(1/S₁₆)=⅓+⅓=⅔

Node 3: S₃=(1/S₃₁)+(1/S₃₆)=⅓+⅓=⅔

Node 6: S₆=(1/S₆₁)+(1/S₆₃)=⅓+⅓=⅔

Overall Score=S₁+S₃+S₆=⅔+⅔+⅔=2

Project creator 18 can also determine a compatibility metric for the second suggested project team using approach 3 (Triangle Density Metrics) as shown below:

Overall Score=(I₁₃I₁₆I₃₆+I₃₆I₃₁I₁₆+I₆₃I₆₁I₃₁)/(I₁₃I₁₆+I₃₆I₃₁+I₆₃I₅₁)=(0+0+0)/(1+1+1)=0

Based on the compatibility metric scores determined for each of the suggested project teams shown in FIGS. 5-7, project team creator 18 can rank the suggested project teams based on prior professional association.

Project creator 18 can rank the suggested project teams based on prior professional associations using approach 1 (Simple Density Metric) as follows:

Team 1>Team 2>Team 3.

Project creator 18 can rank the suggested project teams based on prior professional association using approach 2 (Reciprocal Density Metric) as follows:

Team 1>Team 2>Team 3.

Project creator 18 can rank the suggested project teams based on prior professional associations using approach 3 (Triangular Density Metric) as follows:

Team 1>Team 2=Team 3.

In embodiments where the graphical visualization of each of the suggested project teams is displayed, the user can view the graphical visualization and rank the visual representation as follows:

Team 1>Team 2>Team 3.

In such embodiments, the graphical visualization of the suggested project teams can further aid the user to choose the most optimal team.

In some embodiments, project creator 18 suggests multiple project teams and the highest ranked suggested team may not automatically be selected. For example, a project manager may wish to select the first suggested project team shown in FIG. 5 for his project in case he wants a very well gelled team that can hit the ground running from day one. In such example, the project manager may also be interested in finding project team with the most dense network connections (e.g., FIG. 5) so that the project team will hit the ground running from day one.

In another example, a resource manager may wish to select the second suggested project team shown in FIG. 6 or the third suggested project team shown in FIG. 7, in case the resource manager wants to foster new professional associations between team members (e.g., the resource manager may select a project team that is best aligned with the goal of a team that will result in closer and denser network connections at an organizational level). A resource manager may, based on a project demand profile request received from project manager, assign resources to a project team from the enterprise resource pool. A resource manager may be interested in ultimately creating project teams that, apart from satisficing the project demand profile, also result in closer and denser network connection at an organizational level. A resource manager may also be interested in fostering new connections between previously unconnected nodes, while selecting a project team.

In some embodiments, for example, the rank of the suggested project teams are determined without causing graphical representations of the suggested teams to be displayed when the enterprise resource pool is large because it may be difficult to display and/or view graphs of suggested teams selected from the large enterprise resource pool.

In some embodiments, project creator 18 can be configured to automatically select one of the suggested project teams. For example, project creator 18 can be configured to automatically select the suggested team with the most dense network connections based on one or more of the compatibility metrics described above (e.g., the optimal team from a typical program manager's viewpoint), the least dense network connections based on one or more of the compatibility metrics described above (e.g., to allow the enterprise's resources to create new links and/or connections with others), or somewhere in between (e.g., the middle ranked suggested team based on one or more of the compatibility metrics described above).

As disclosed, embodiments comprise a system that generates and ranks combinations of resources to staff a project team based on a compatibility metric.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to recommend project teams, the recommending comprising:
providing a project demand profile;
generating a plurality of suggested project teams, the generating including building a graph of each of the plurality of suggested project teams;
determining a compatibility metric for each of the plurality of suggested project teams;
determining a ranking of each of the plurality of suggested project teams based on the corresponding compatibility metric; and
outputting the ranking of each of the plurality of suggested project teams and the graph of each of the plurality of suggested project teams.

2. The computer readable medium of claim 1,
wherein the graph is a canonical undirected graph including a plurality of nodes corresponding to a plurality of available resources in an enterprise resource pool, and
wherein a connection between two nodes of the graph represents a prior professional association between the corresponding resources.

3. The computer readable medium of claim 1, wherein the determining a compatibility metric includes determining a Simple Density Metric compatibility score for each of the plurality of suggested project teams.

4. The computer readable medium of claim 1, wherein the determining a compatibility metric includes determining a Reciprocal Density Metric compatibility score for each of the plurality of suggested project teams.

5. The computer readable medium of claim 1, wherein the determining a compatibility metric includes determining a Triangular Density Metric compatibility score for each of the plurality of suggested project teams.

6. The computer readable medium of claim 1, wherein the determining a compatibility metric includes:
determining a Simple Density Metric compatibility score for each of the plurality of suggested project teams;
determining a Reciprocal Density Metric compatibility score for each of the plurality of suggested project teams; and
determining a Triangular Density Metric compatibility score for each of the plurality of suggested project teams.

7. The computer readable medium of claim 1, wherein the outputting comprises displaying the ranking of each of the plurality of suggested project teams and the graph of each of the plurality of suggested project teams on a display.

8. A computer-implemented method for recommending project teams, the computer-implemented method comprising:
providing a project demand profile;
generating a plurality of suggested project teams, the generating including building a graph of each of the plurality of suggested project teams;
determining a compatibility metric for each of the plurality of suggested project teams;
determining a ranking of each of the plurality of suggested project teams based on the corresponding compatibility metric; and
outputting the ranking of each of the plurality of suggested project teams and the graph of each of the plurality of suggested project teams.

9. The computer-implemented method of claim 8,
wherein the graph is a canonical undirected graph including a plurality of nodes corresponding to a plurality of available resources in an enterprise resource pool, and
wherein a connection between two nodes of the graph represents a prior professional association between the corresponding resources.

10. The computer-implemented method of claim 8, wherein the determining a compatibility metric includes determining a Simple Density Metric compatibility score for each of the plurality of suggested project teams.

11. The computer-implemented method of claim 8, wherein the determining a compatibility metric includes determining a Reciprocal Density Metric compatibility score for each of the plurality of suggested project teams.

12. The computer-implemented method of claim 8, wherein the determining a compatibility metric includes determining a Triangular Density Metric compatibility score for each of the plurality of suggested project teams.

13. The computer-implemented method of claim 8, wherein the determining a compatibility metric includes:
determining a Simple Density Metric compatibility score for each of the plurality of suggested project teams;
determining a Reciprocal Density Metric compatibility score for each of the plurality of suggested project teams; and
determining a Triangular Density Metric compatibility score for each of the plurality of suggested project teams.

14. The computer-implemented method of claim 8, wherein the outputting comprises displaying the ranking of each of the plurality of suggested project teams and the graph of each of the plurality of suggested project teams on a display.

15. A system comprising:
a memory device configured to store a project team creator module;
a processing device in communication with the memory device, the processing device configured to execute the project team creator module stored in the memory device to recommend project teams, the recommending comprising:
providing a project demand profile;
generating a plurality of suggested project teams, the generating including building a graph of each of the plurality of suggested project teams;
determining a compatibility metric for each of the plurality of suggested project teams;
determining a ranking of each of the plurality of suggested project teams based on the corresponding compatibility metric; and
outputting the ranking of each of the plurality of suggested project teams and the graph of each of the plurality of suggested project teams.

16. The system of claim 15,
wherein the graph is a canonical undirected graph including a plurality of nodes corresponding to a plurality of available resources in an enterprise resource pool, and
wherein a connection between two nodes of the graph represents a prior professional association between the corresponding resources.

17. The system of claim 15, wherein the determining a compatibility metric includes determining a Simple Density Metric compatibility score for each of the plurality of suggested project teams.

18. The system of claim 15, wherein the determining a compatibility metric includes determining a Reciprocal Density Metric compatibility score for each of the plurality of suggested project teams.

19. The system of claim 15, wherein the determining a compatibility metric includes determining a Triangular Density Metric compatibility score for each of the plurality of suggested project teams.

20. The system of claim 15, wherein the determining a compatibility metric includes:
determining a Simple Density Metric compatibility score for each of the plurality of suggested project teams;
determining a Reciprocal Density Metric compatibility score for each of the plurality of suggested project teams; and
determining a Triangular Density Metric compatibility score for each of the plurality of suggested project teams.
